(19) United States
(12) Patent Application Publication
(10) Pub. No.: US 2026/0108768 A1
(43) Pub. Date: Apr. 23, 2026

(54) A FIRE MONITORING MANAGEMENT SYSTEM AND METHOD

(71) Applicant: BTS KURUMSAL BILISIM TEKNOLOJILERI ANONIM SIRKETI, Atasehir/Istanbul (TR)

(72) Inventors: Sultan ÇOGAY, Sariyer/Istanbul (TR); Gökhan SEÇINTI, Sariyer/Istanbul (TR); Gökhan YURDAKUL, Üsküdar/Istanbul (TR); Özgür PALANTÖKEN, Pendik/Istanbul (TR)

(21) Appl. No.: 19/116,351

(22) PCT Filed: Dec. 29, 2023
(86) PCT No.: PCT/TR2023/051859

§ 371 Date: Mar. 27, 2025

(30) Foreign Application Priority Data
Dec. 20, 2023 (TR) 2023/017793

(51) Int. Cl. A62C 3/02; A62C 37/00; G05D 1/644; G05D 105/55; G05D 109/20

(52) U.S. Cl. CPC A62C 3/0271; A62C 37/00; G05D 1/644; G05D 2105/55; G05D 2109/20

(57) ABSTRACT

The invention relates to a system which monitors the forest fires, plans to extinguish small-scale fires before they grow, and prepares an effective action plan for controlling and extinguishing large and widely spread fires, and to a method ensuring the operation of the system.

### TECHNICAL FIELD

The invention relates to a system which monitors the forest fires, plans to extinguish small-scale fires before they grow, and prepares an effective action plan for controlling and extinguishing large and widely spread fires, and to a method ensuring the operation of the system.

### STATE OF THE ART

Today, efforts to fight and control fires have begun to develop rapidly with the increasing number of fires. In particular, aerial firefighting plays a critical role in extinguishing fires, while the strategic use of the unmanned aerial vehicles (UAVs) has also increased considerably. Furthermore, large-scale forest fires are more difficult to fight than the small-scale fires. The environmental conditions of forested lands, such as a mountainous and hilly terrain, may affect the direct response to the fire. In addition, the density of trees can also prevent access to the fire area. Due to these factors, UAVs are of great importance in fire monitoring.

In the present art, forest fire monitoring and detecting studies are mostly machine learning-based solutions and often use convolutional neural networks (CNNs). However, these solutions require huge amount of data and contain applications with high computational complexity. Furthermore, it requires a high computing and processing power. It is very difficult and inefficient to adapt applications that require such data and calculation to real-time systems.

Other applications in the state of the art are the use of the monitoring methods using satellite data and the wireless sensor networks. In addition, there are solutions that make use of different fire models. For example, an elliptical fire model is a physical fire model. This model addresses the structure and progression of fire using a wave principle and examines based on an elliptical trajectory. [1]. However, all of these solutions address the fire from one perspective. It focuses on the environmental factors and fails to interpret the fire structure, or focuses only on the fire and neglects the factors that have a direct effect. In addition, problems that need to be solved, such as energy consumption which may be caused by the use of UAVs, cannot be solved in the studies included in the present art.

In the state of the art and in order to eliminate the above-mentioned disadvantages, new systems and methods need to be developed.

### SUMMARY OF THE INVENTION

The present invention relates to a system which monitors the forest fires, plans to extinguish small-scale fires before they grow, and prepares an effective action plan for controlling and extinguishing large and widely spread fires, and to a method ensuring the operation of the system, in order to eliminate the above mentioned disadvantages and provide the related technical field with new advantages.

The invention assists the fire extinguishing units for the monitoring of fires considering the factors affecting the forest fires and offers solutions to provide an optimal energy use and an efficient monitoring.

The system and method of the invention provide the ability to navigate the UAV with a high precision in fire areas and optimize its trajectory for fire area coverage by its path planning module, graph engine and modified traveling salesman problem (TSP) module. The invention provides an advanced fire monitoring system by significantly shortening the fire response time and reducing the rapid spread of forest fires.

The monitoring data of the UAVs are sent to the fire department and the other firefighting units quickly and smoothly by the ground control unit included in the system and method of the invention. The resulting real-time updates on current conditions on the ground enable firefighting teams to make the right decisions and improve coordination efforts. The uninterrupted flow of information obtained by the invention becomes a more synchronized and effective firefighting approach, thus the possibility of successfully controlling and extinguishing the fire is increased.

The elliptical fire model obtained by the invention addresses the physical characteristics of fires. The invention makes a calculation using said model, while the invention physically interprets the movements and progress of the fire based on a wave principle, considering the environmental factors, such as wind speed, for the movement calculations. Thus, it allows the UAVs to stay in the air for a long time, facilitating a more comprehensive and in-depth examination of the large geographical regions.

The energy optimization achieved by the energy module contained in the invention enables the UAVs to cover larger areas and detect potential fire threats more comprehensively. Thus, the overall efficiency of firefighting operations is significantly increased. In addition, the firefighting teams are enabled to adapt their strategies according to changing fuel conditions by the graph engine of the invention, increasing the probability of achieving successful results in fighting forest fires. In the fire area analysis, the chemical character of the fire is interpreted by including the fuel moisture content data which directly affects the fires spread factor.

### DESCRIPTION OF THE FIGURES

Embodiments of the present invention which are briefly summarized above and discussed in more detail below, may be understood by referring to the exemplary embodiments of the invention illustrated in the accompanying drawings. It should be noted, however, that the accompanying drawings only depict typical embodiments of this invention and are not to be construed as limiting the scope thereof.

FIG. 1. is a representative view of a diagram showing the principle of the operation of the invention.

FIG. 2. is a representative view of a diagram showing the principle of operation of the method according to the invention.

FIG. 3. is a representative view of a diagram showing the principle of operation of the method according to the invention.

FIG. 4. is a representative view of a diagram showing the principle of operation of the method according to the invention.

FIG. 5. is a representative view of a diagram showing the topology design and path planning of the invention.

FIG. 6. is a representative view illustrating the use of the elliptical fire model of the invention.

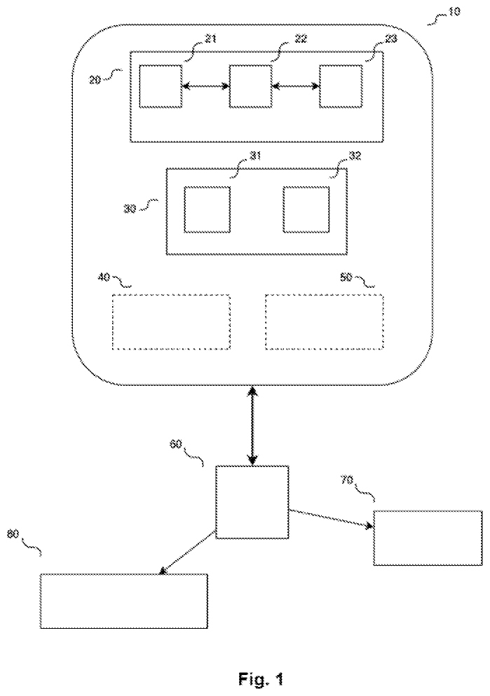

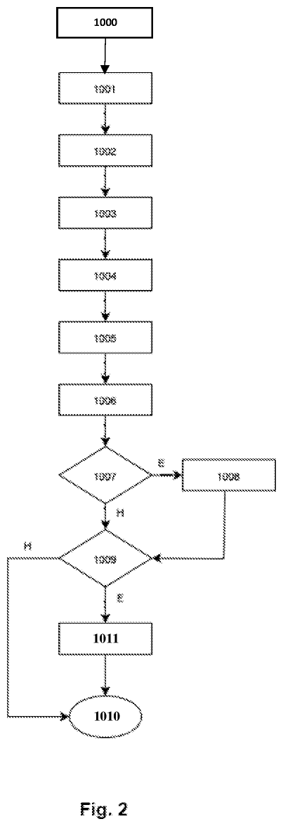

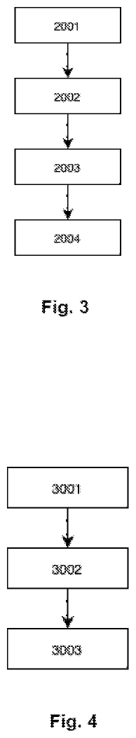

### DESCRIPTION OF THE REFERENCES IN THE FIGURES

In order to provide a better understanding of the invention, the numerals in the figures are provided below:
Y. Yes
N. No
C. Cost
G. Graph
G′. Changed Graph
SFM. Simulation and Fire Model
FP. Fire Point
I. Ignition Point
W. Wind
EF. End of Fire
h. Height
φ. First Coverage Angle
α. Second Coverage Angle
10. Unmanned Aerial Vehicle (UAV)
20. First Controller
21. Graph Engine
22. Path Planning Module
23. Modified Traveling Salesman (TSP) Module
30. Second Controller
31. Energy Module
32. Coverage Module
40. Monitoring Unit
50. Warning Unit
60. Ground Control Unit
70. Charging Station
80. Fire Support Module
1000. starting the flight of the UAV under the supervision and control of the ground control unit, activating the first controller which provides topology design and path planning, obtaining the fire starting points from the monitoring unit and sending them to the path planning module
1001. creating the graph (G) using the fire starting points and elliptical fire model by the path planning module and sending the resulting graph (G) to the graph engine
1002. running the graph engine with the obtained graph and obtaining a new graph suitable for the fire monitoring,
1003. sending the resulting graph to the modified TSP module to obtain a flight plan and calculating the cost
1004. determining the height and flight time parameters, which are the optimal parameters for flight, by the energy module and the coverage module using the second controller which is the optimization center
1005. informing the warning unit by the path planning module based on the energy consumption and displayed area coverage rate
1006. informing the ground control unit of a fire situation and the battery level of the UAV by the warning unit and the monitoring unit
1007. Determining whether or not the ground control unit needs fire support
1008. requesting support from the assistive fire teams by the fire support module,
1009. Deciding, by the ground control unit, whether or not the UAV needs to be charged
1010. If the monitored area has reached the threshold monitoring area, sending the area to be monitored back to the ground control center
1011. Directing the mobile charging station to an available place where the UAV may be charged
2001. determining the fuel moisture content values on the graph by the graph engine
2002. comparing the fuel moisture content values of the paths in the graph (G) with the threshold value, defining a priority for the paths with a fuel moisture content value less than the threshold value
2003. comparing the temperature values of the fire clusters in the graph with the threshold values and removing the paths greater than the temperature threshold value from the graph
2004. creating a new graph based on the updated values and sending the same to the path planning module
3001. determining the flight starting point by the modified TSP module
3002. Extracting a flight path by the modified TSP algorithm based on the priority paths and fire points in the graph
3003. Calculating the path cost of the obtained flight path

### DETAILED DESCRIPTION OF THE INVENTION

Exemplary embodiments are described in more detail below with reference to the accompanying descriptions. However, embodiments may be constructed in different forms and should not be construed as limited to the embodiments set forth herein. Instead, these exemplary embodiments are provided for this disclosure to be exactly and to fully understood by those skilled in the art.

The invention relates to a system which prepares an effective action plan for monitoring the forest fires, planning to extinguish small-scale fires before they grow and controlling and extinguishing large and widely spread fires in order to provide an improvement supported by machine learning comprising a processor, characterized in that it comprises:
at least one unmanned aerial vehicle (UAV) (10) which displays the forest fires and sends said images from a monitoring unit (40) to a ground control unit (60);
at least one first controller (20) which manages a graph engine (21), a path planning module (22) and an modified traveling salesman (TSP) module (23) and performs a topology design and flight path planning,
at least one graph engine (21) which enables the fire points and clusters in the graph (G) created with the path planning module (22) to be controlled and prioritized based on the fuel moisture content and the paths to be controlled and prioritized based on the safe temperature values, removes paths which are not safe and obtains a new graph,
at least one path planning module (22) which identifies the potential danger zones using an elliptical fire model and a simulation and activates the graph engine (21) and the modified traveling salesman (TSP) module (23),
at least one modified traveling salesman (TSP) module (23) which determines a flight map by calculating the cost (C) via the new routes modified in the graph engine (21),
at least one second controller (30) which is an optimization center managing an energy module (31) and a coverage module (32), which enables the optimization operations to be carried out,
at least one energy module (31) which minimizes the energy use of the UAV (10) during flight,
at least one coverage module (32) which allows the UAV (10) to adequately monitor the flight fire area and to control the increase of the displayed area per unit time,
at least one monitoring unit (40) which sends the images obtained from the UAV (10) to the ground control unit (60),
in cases where an additional support is required during fire, at least one warning unit (50) which provides situation notification warnings in coordination with the ground control unit (60),
at least one ground control unit (60) which provides ground control of the UAV (10), manages the mobile charging station (70) and fire support module (80) and establishes information flow,
at least one mobile charging station (70) which charges the UAV (10),
at least one fire support module (80) which allows the teams who will assist in fire extinguishing and provide emergency health assistance to be guided to the area when needed by the ground control unit (60).

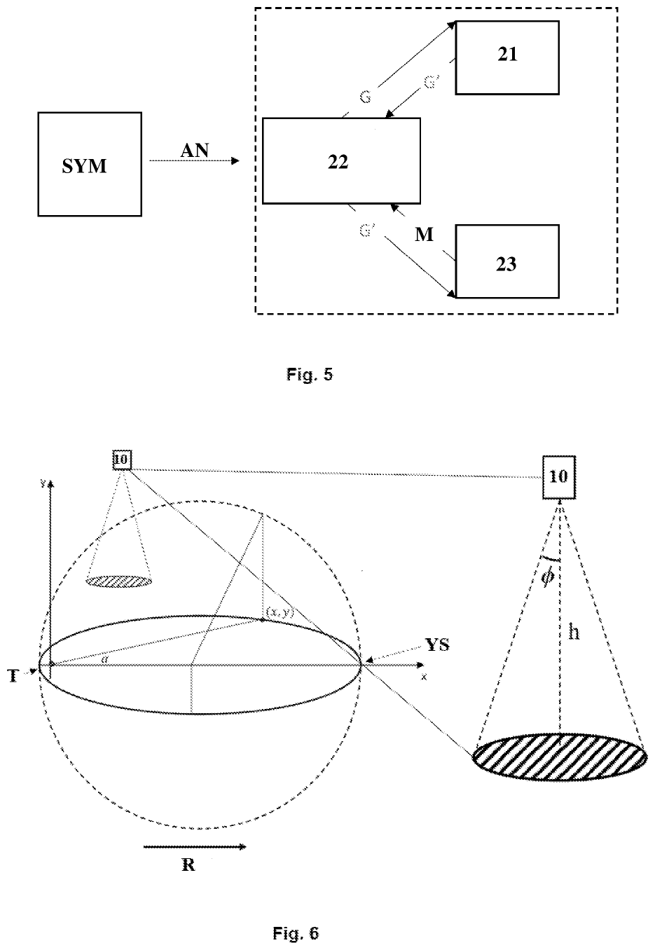

In a diagram showing the topology design and path planning of the system described in FIG. 5, the simulation and fire model (SFM) created shows the graph (G), changed graph (G′) and cost (C) relationship between the graph engine (21), the path planning module (22) and the modified traveling salesman (TSP) module (23) by determining the fire point (FP) in the created simulation and fire model (SFM). Also, said diagram shows a brief representative view of the relationship between the steps 1001, 1002, 1003, 2001, 2002, 2003, 2004, 3001, 3002, and 3003 among the method steps listed below in the diagram.

Using the elliptical fire model and fire ignition points mentioned in FIG. 6, a graph (G) is created by the path planning module (22). The elliptical fire model refers to the progress of the fire on a coordinate plane with the ignition point (I) until the end of the fire (EF). The invention allows the progression and progression points of the fire to be calculated using the elliptical fire model. In the figure shown, an angle between the points (x, y), which is the region where the UAV (10) monitors instantaneously and the ignition point (I) is a second coverage angle, alpha (α). The UAV (10) monitors the corresponding area at a height of “h” and the angle between it and the ground is a first coverage angle (φ). By using said model, the fire points are obtained by predicting where the fire will spread. The elliptical fire model is a physical fire model and the invention represents the physical properties of the fire. In other words, said model addresses the structure and progression of fire using a wave principle and examines based on an elliptical trajectory.

In the invention, the method for operating the system which monitors the forest fires, plans to extinguish small-scale fires before they grow and prepares an effective action plan for controlling and extinguishing large and widely spread fires in order to provide an improvement supported by machine learning comprising a processor comprises the steps of:
starting the flight of the UAV (10) under the supervision and control of the ground control unit (60), activating the first controller (20) which provides topology design and path planning (PP), obtaining the fire starting points from the monitoring unit (40) and sending them to the path planning module (22) (1000),
creating the graph (G) using the fire starting points and elliptical fire model by the path planning module (22) and sending the resulting graph (G) to the graph engine (21) (1001),
running the graph engine (21) with the obtained graph (G) and obtaining a new graph suitable for the fire monitoring (1002),
sending the resulting graph to the modified TSP module (23) to obtain a flight plan and calculating the cost (C) (1003),
determining the height (h) and flight time parameters, which are the optimal parameters for flight, by the energy module (31) and the coverage module (32) using the second controller (30) which is the optimization center (1004),
informing the warning unit (50) by the path planning module (22) based on the energy consumption and monitored area coverage rate (1005),
informing the ground control unit (60) of a fire situation and the battery level of the UAV (10) by the warning unit (50) and the monitoring unit (40) (1006),
determining whether the ground control unit (60) needs fire support (1007) and proceeding to step 1008 when the fire support is needed, or proceeding directly to step 1009 when the fire support is not needed,
requesting support from the assistive fire teams by the fire support module (80) (1008),
deciding, by the ground control unit (60), whether the UAV (10) needs charging (1009), and if there is a need for charging, proceeding to step 1011, or if there is no need for charging, sending the area to be monitored back to the ground control center (60) in case that the area to be monitored is completed and the monitored area has reached the coverage area threshold (1010),
directing the mobile charging station (70) to an optimal position where the UAV (10) may be charged (1011).

In the step 1001 of the method according to the invention, the path planning module (22) uses the starting points in the elliptical fire model to create a potential fire scenario by simulating, i.e., realizing, the fire in a simulator, and a graph (G) is created according to the scenario. In said graph (G), the nodes (vertices) represent the fire points and clusters, and the paths (edges) represent the distances between the fire points. The path planning module (22) sends the obtained graph (G) to the graph engine (21). Thus, a real-like flight map is obtained as the fire model and fire simulation are used in the graph (G) obtained on how the fire will progress before the fire progresses.

In the step 1002 of the method according to the invention, the graph engine (21) divides the fire area into small sub-areas. The fuel moisture content values corresponding to these small areas are determined. The values in the graph (G) and areas are compared. If a fire cluster has a fuel moisture content value less than the threshold value, that fire cluster is considered as priority cluster. Then, the graph (G) paths and the related areas are assessed in terms of temperature. If the temperature values exceed a safe temperature threshold value, that path is removed from the graph (G). After a revision process, a new graph is obtained. Thus, which areas will ignite quickly and more during fire and the flight areas which may pose a danger to UAVs (10) will be determined. As the fuel moisture content directly affects the ignition and combustion, said situations are known in advance and an action is taken according thereto. Moreover, the UAV (10) losses and extra energy consumption are avoided by detecting the places where a flight cannot be made in terms of temperature.

In the step 1004 of the method according to the invention, the first controller (20) determines the flight parameters with the second controller (30) after calculating the flight plan and cost (C). An example topology design and path planning (PP) system provided by said first controller (20) is shown in FIG. 5. The energy module (31) calculates the energy used and optimizes the flight time and flight height. The flight height is important in terms of both energy consumed and risks arising from fire. The energy consumption and battery status arising from the flight time are assessed. Battery consumption times are reported to the first controller (20). The coverage module (32) compares fire areas and the monitored areas. It also tries to maximize the areas to be monitored. Said coverage module (32) assess the area where the flight is made based on the threshold coverage value and notifies the first controller (20) if the monitored area is insufficient. Thus, the energy consumed is controlled, and said energy is tried to be minimized. Together with the coverage module (32), the minimized energy consumption provides an advantage in the adequate and detailed monitoring of the fire area by the UAV (10).

In the step 1005 of the method according to the invention, the path planning module (22) provides information to the warning unit (50) based on the status of the flight plan, energy consumption and coverage rate. Thus, in cases where an additional support is required for the ground units for fire or health control, the warning unit (50) and the ground control unit (60) quickly provide support. In addition, it provides an advantage in informing other units.

In the step 1006 of the method according to the invention, the warning unit (50) sends important situations that need to be communicated to the ground control unit (60) based on the fire situation assessment received from the path planning module (22) and the monitoring unit (40). In this way, it is ensured that the ground control unit (60) is aware of whether an additional fighting operation is required for the fire and the battery level, and an advantage is provided in advance to take precautions and other necessary steps accordingly.

In the steps 1007-1010 of the method according to the invention, the ground control unit (60), if necessary, requires the assistive teams, for example, mobile fire extinguishing teams and healthcare personnel to provide support by means of the fire support module (80) and directs the mobile charging station (70) to the most suitable location where the UAV (10) will charge. The UAV (10) is enabled to be charged and to continue to function uninterruptedly without loss of time when necessary, thus ensuring a rapid response to the fire and preventing an increase in casualties.

Among the steps of the method according to the invention, the steps of obtaining a new graph by updating the graph (G) created in the step (1001) of creating the graph (G) in the path planning module (22) using the fire starting points and the elliptical fire model with the graph engine (21) are provided below:
determining the fuel moisture content values on the graph (G) by the graph engine (21) (2001),
comparing the fuel moisture content values of the paths in the graph (G) with the threshold value and defining a priority for the paths with a fuel moisture content value less than the threshold value (2002),
comparing the temperature values of the fire clusters in the graph (G) with the threshold values and subtracting the paths greater than the temperature threshold value from the graph (G) (2003),
creating a new graph based on the updated values and sending the same to the path planning module (22) (2004).

In the step 2002 of the method according to the invention, the fuel moisture content values on the graph (G) obtained by means of the graph engine (21) and the elliptical fire model are calculated. For this calculation, the corresponding area is divided into equal and small areas, and the fuel moisture content per unit area is calculated by subtracting the dry fuel weight from the wet fuel weight and dividing it by the dry fuel weight.

In the step 2003 of the method according to the invention, the environment temperature values obtained from the sensors during the flight are compared with the threshold temperature value, and the threshold temperature value is calculated based to the temperature value that may damage the UAV (10).

The process of sending the graph (G) obtained by the method of the invention to the modified TSP (23) module to obtain a flight plan and calculate the cost (C) (1003) comprises the following method steps of:
determining the flight starting point by the modified TSP (23) module (3001),
extracting a flight path by the modified TSP algorithm based on the priority paths and points in the graph (G) (3002),
calculating the path cost (C) of the extracted flight path (3003).

In the step 1003 of the method according to the invention, the path planning module (22) sends the newly obtained graph (G) to the modified TSP module (23). The modified TSP module (23) selects a starting point from the newly created graph (G). Then, the modified TSP algorithm creates a flight plan, taking into account the determined priorities and qualifications. Said flight plan is directly associated with the fuel moisture content and temperature values. In addition, cost (C) is calculated according to the flight plan. Thus, a flight planning is achieved with the lowest cost according to both fuel moisture content and regional temperatures.

Any features described in this specification (including attached claims, abstract and drawings) may be replaced by other alternative features that may have equivalent or similar purposes, unless expressly stated otherwise. That is, unless explicitly stated otherwise, each feature is only one instance of a set of equivalent or similar features.

The terminology used in this specification is intended to be used only to describe a specific exemplary embodiment and is not intended to be restrictive. As used herein, the context of the forms “one”, “at least”, “preferably” and “and/or” also includes plural forms unless expressly stated otherwise. When the terms “contains” and/or “including” are used in this specification, they include the presence or addition of specified properties, integers, steps, operations, elements, and/or components, but do not preclude one or more other features, integers, steps, operations, elements, and/or components.

The above embodiments are intended only to describe the technical concept and characteristics of the present invention, and the object of the present invention is to enable the skilled one in the art to understand the content of the present invention and implement the present invention, and the scope of the present invention is not limited thereto. Equivalent alterations or modifications made in accordance with the spirit of the invention are intended to be included in the scope of the invention.

### INDUSTRIAL APPLICABILITY OF THE INVENTION

The invention relates to a system which monitors the forest fires, plans to extinguish small-scale fires before they grow, and prepares an effective action plan for controlling and extinguishing large and widely spread fires, and to a method ensuring the operation of the system, and has an industrial applicability.

The invention is not limited to the above exemplary embodiments, and a person skilled in the art may easily present other different embodiments of the invention. These should be considered within the scope of protection of the invention claimed in the claims.

### REFERENCES

[1] Perry, G. L. Current approaches to modelling the spread of wildland fire: A review. Prog. Phys. Geogr. Earth Environ. 1998, 22, 222-245.

1. A system which monitors the forest fires, plans to extinguish small-scale fires before they grow and prepares an effective action plan for controlling and extinguishing large and widely spread fires in order to provide an improvement by a processor-containing computer-aided machine learning,
characterized in that it comprises at least one unmanned aerial vehicle (UAV) (10) which monitors the forest fires and sends said images from an monitoring unit (40) to a ground control unit (60);
and that it comprises at least one first controller (20) which manages a graph engine (21), a path planning module (22) and an modified traveling salesman (TSP) module (23) and performs a topology design and flight path planning,
at least one graph engine (21) which enables the fire points and clusters in the graph (G) created with the path planning module (22) to be controlled and prioritized based on the fuel moisture content and the paths to be controlled and prioritized based on the safe temperature values, removes dangerous paths and obtains a new graph,
at least one path planning module (22) which identifies the potential danger zones using an elliptical fire model and a simulation and triggers the operation of the graph engine (21) and the modified traveling salesman (TSP) module (23),
at least one modified traveling salesman (TSP) module (23) which determines a flight map by calculating the cost (C) via the new routes modified in the graph engine (21),
at least one second controller (30) which is an optimization center managing an energy module (31) and a coverage module (32), which enables the optimization operations to be carried out,
at least one energy module (31) which minimizes the energy use of the UAV (10) during flight,
at least one coverage module (32) which allows the UAV (10) to adequately monitor the flight fire area and to control the increase of the displayed area per unit time,
at least one monitoring unit (40) which sends the images obtained from the UAV (10) to the ground control unit (60),
in cases where an additional support is required during fire, at least one warning unit (50) which provides situation notification warnings in coordination with the ground control unit (60),
at least one ground control unit (60) which provides ground control of the UAV (10) manages the mobile charging station (70) and fire support module (80) and establishes information flow,
at least one mobile charging station (70) which charges the UAV (10),
at least one fire support module (80) which allows the teams who will assist in fire extinguishing and provide emergency health assistance to be guided to the area when needed by the ground control unit (60).

2. A method for operating the system which prepares an effective action plan for monitoring the forest fires, planning to extinguish small-scale fires before they grow and controlling and extinguishing large and widely spread fires in order to provide an improvement supported by machine learning comprising a processor, characterized in that it comprises the steps of:
starting the flight of the UAV (10) under the supervision and control of the ground control unit (60), activating the first controller (20) which provides topology design and path planning (PP), obtaining the fire starting points from the monitoring unit (40) and sending them to the path planning module (22) (1000),
creating the graph (G) using the fire starting points and elliptical fire model by the path planning module (22) and sending the resulting graph (G) to the graph engine (21) (1001),
running the graph engine (21) with the obtained graph (G) and obtaining a new graph suitable for the fire monitoring (1002),
sending the resulting graph to the modified TSP module (23) to obtain a flight plan and calculating the cost (C) (1003),
determining the height (h) and flight time parameters, which are the optimal parameters for flight, by the energy module (31) and the coverage module (32) using the second controller (30) which is the optimization center (1004),
informing the warning unit (50) by the path planning module (22) based on the energy consumption and monitored area coverage rate (1005),
informing the ground control unit (60) of a fire situation and the battery level of the UAV (10) by the warning unit (50) and the monitoring unit (40) (1006),
determining whether the ground control unit (60) needs fire support (1007) and proceeding to step 1008 when the fire support is needed, or proceeding directly to step 1009 when the fire support is not needed,
requesting support from the assistive fire teams by the fire support module (80) (1008),
deciding, by the ground control unit (60), whether the UAV (10) needs charging (1009), and if there is a need for charging, proceeding to step 1011, or if there is no need for charging, sending the area to be displayed back to the ground control center (60) in case that the area to be monitored is completed and the monitored area has reached the coverage area threshold (1010),
directing the mobile charging station (70) to an available place where the UAV (10) (1011) can be charged.

3. A method according to claim 2, for obtaining a new graph by updating the graph (G) created in the step (1001) of creating the graph (G) in the path planning module (22) using the fire starting points and the elliptical fire model with the graph engine (21), characterized in that it comprises the steps of:
determining the fuel moisture content values on the graph (G) by the graph engine (21) (2001),
comparing the fuel moisture content values of the paths in the graph (G) with the threshold value and defining a priority for the paths with a fuel moisture content value less than the threshold value (2002),
comparing the temperature values of the fire clusters in the graph (G) with the threshold values and subtracting the paths greater than the temperature threshold value from the graph (G) (2003),
creating a new graph based on the updated values and sending the same to the path planning module (22) (2004).

4. A method according to claim 3, for sending the obtained graph (G) to the modified TSP (23) module to obtain a flight plan and calculate the cost (C) (1003), characterized in that it comprises the steps of:
determining the flight starting point by the modified TSP (23) module (3001),
Extracting a flight path by the modified TSP algorithm based on the priority paths and points in the graph (G) (3002),
calculating the path cost (C) of the extracted flight path (3003).
